(19) United States
(12) Patent Application Publication
(10) Pub. No.: US 2019/0087636 A1
(43) Pub. Date: Mar. 21, 2019

(54) COMMUNICATION OF FINGERPRINT DATA

(71) Applicant: Microsoft Technology Licensing, LLC, Redmond, WA (US)

(72) Inventors: Mingjie WANG, Beijing (CN); Allen XIA, Beijing (CN); Landi HU, Beijing (CN)

(73) Assignee: Microsoft Technology Licensing, LLC, Redmond, WA (US)

(21) Appl. No.: 16/083,792

(22) PCT Filed: Mar. 25, 2016
(86) PCT No.: PCT/CN2016/077329

§ 371 Date: Sep. 10, 2018

(51) Int. Cl. G06K 9/00; G06K 9/03; G06F 21/32

(52) U.S. Cl. CPC G06K 9/00087; G06F 21/32; G06K 9/036

(57) ABSTRACT

Communication of fingerprint data is described herein. In one or more implementations, a fingerprint sensor is integrated within a device separate from a host device that identifies users utilizing fingerprint data. Although separate, the fingerprint-scanning device is communicably coupled to the host device. Unlike conventional fingerprint-based user identification techniques which involve communication of a stream of data comprising multiple fingerprint images, the techniques described herein involve communication of a single frame of fingerprint data for a user identification. The fingerprint-scanning device applies techniques so that a quality of the single frame enables recognition of a fingerprint from the single frame, e.g., recognition that the fingerprint corresponds to a particular user.

### BACKGROUND

A variety of kinds of computing devices have been developed to provide computing functionality to users in different settings. For example, a user may interact with a mobile phone, tablet computer, wearable device or other computing device to check email, surf the web, compose texts, interact with applications, and access other resources. The use of biometric technology to facilitate user access to their devices and/or authentication to access resources is increasing due to security demands and potential for biometric technology to make access and authentication quick and easy. Today, fingerprint sensing technology is a widely used form of biometric technology and various types of fingerprint sensors are available.

In traditional arrangements, fingerprint sensors are configured to capture fingerprint data and communicate a stream of data to a host device for processing. The stream of fingerprint data encompasses multiple discrete frames of captured data that are indicative of unique patterns and features of prints used for user identification and authentication. In the traditional approach, the host device analyzes the stream of data to extract fingerprint candidates and compares the fingerprint candidates to templates of known fingerprints for authentication purposes. Capturing, communicating and processing of the stream of data may consume considerable processing capacity, device memory, bandwidth, and/or power. Consequently, traditional approaches to fingerprint recognition may not be suitable for scenarios in which there are limitations on or concern regarding allocation of processing resources, memory usage, communication bandwidth, and/or power consumption.

### SUMMARY

Communication of fingerprint data is described herein. In one or more implementations, a fingerprint sensor is integrated within an input device connected to a host device that processes fingerprint data supplied by the fingerprint sensor. Unlike conventional fingerprint-based user identification techniques which involve communication of a stream of data between the fingerprint sensor and the host, the techniques described herein involve communication of a single frame of fingerprint data for recognition. The fingerprint-sensing device, for instance, may communicate just a single frame of fingerprint data to the host device for a particular user identification. The fingerprint-sensing device applies the techniques described herein to ensure quality of the single frame is sufficient to enable recognition of a fingerprint therefrom. In other words, the quality of the single frame is controlled such that other frames of fingerprint data are not required to recognize the fingerprint. A designated level of quality may be obtained by analyzing quality indicators specified for capturing fingerprint data as criteria for selection of frames of fingerprint data. Based on the analysis, a single frame of fingerprint data that meets the criteria can be selected to utilize for a user identification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment that is operable to employ the communication of fingerprint data techniques described herein in accordance with one or more implementations.

FIG. 2 depicts an example implementation of an input device of FIG. 1 in greater detail.

FIG. 3 depicts an example timeline of operations performed by and data communicated between particular components of the environment of FIG. 1, including components of the input device as depicted in FIG. 2.

FIG. 4 depicts an example procedure for reducing an amount of fingerprint data communicated by a fingerprint sensor in association with a fingerprint-based user identification in accordance with one or more implementations.

FIG. 5 depicts an example procedure for utilizing fingerprint data efficiently obtained from a fingerprint sensor in association with a fingerprint-based user identification in accordance with one or more implementations.

FIG. 6 illustrates an example system that includes an example computing device that is representative of one or more computing systems and/or devices that may implement the various techniques described herein.

### DETAILED DESCRIPTION

Overview

Conventional fingerprint sensors may communicate fingerprint data to a host device performing a user identification as a stream of fingerprint data that encompasses multiple discrete frames of fingerprint data. To identify a user, the host device analyzes the stream of data to extract fingerprint candidates and compares the fingerprint candidates to templates of known fingerprints for authentication purposes. However, capturing, communicating, and processing a stream of data may consume considerable processing capacity, device memory, bandwidth, and/or power. Consequently, traditional approaches to fingerprint recognition may not be suitable for scenarios in which there are limitations on or concern regarding allocation of processing resources, memory usage, communication bandwidth, and/or power consumption.

Communication of fingerprint data is described herein. In one or more implementations, a fingerprint sensor is integrated within an input device and supplies fingerprint data to a host device configured to perform fingerprint recognition. The fingerprint-sensing device may be implemented as integrated component of the host device, as a separate device physically connected to the host using a wired connection, or a wireless device that is communicatively coupled to the host device via a wireless connection. In conjunction with a given user identification, the fingerprint-sensing device communicates a single frame of fingerprint data to the host device for processing and recognition by components of the host device.

As part of operations to capture fingerprint data, the fingerprint-sensing device performs checks to ensure that a single frame of fingerprint data communicated meets a threshold quality. Accordingly, the single frame enables the host device to recognize a fingerprint represented by the single without reliance upon additional frames of fingerprint data. Based on recognition of the fingerprint from the single frame, the host device is able to identify a corresponding user and control access to resources accordingly.

Various different techniques to ensure that a quality of the single frame meets an established quality threshold are contemplated. In one example, a controller of a fingerprint-sensing device polls a fingerprint sensor to check whether a finger of the user has at least a threshold amount of contact with the fingerprint sensor. The amount of contact may be measured in terms of surface area, number of points of contact with the fingerprint sensor, amount of pressure applied by the finger, and so forth. In another approach, the quality threshold relates to characteristics of captured frames of data, such as the resolution, size of the captured fingerprint, a measure of frame completeness, and so forth. In any case, the fingerprint-sensing device performs some pre-processing operations when capturing fingerprint data to check whether the established quality threshold is satisfied. When the threshold is met, the controller causes the fingerprint sensor to capture the single frame of fingerprint data. The controller may then utilize a communication interface of the fingerprint-sensing device to communicate the single frame to the host device.

Accordingly, the techniques described herein involve analyzing quality indicators specified for capturing fingerprint data as criteria for selection of frames of fingerprint data (e.g., an amount of contact, image quality, etc.) prior to sending fingerprint data for recognition processing. Based on the analyzing, a single frame of fingerprint data is selected and communicated for fingerprint recognition. By communicating the single frame of fingerprint data, an amount of time, bandwidth, and power consumed for transmitting and analyzing fingerprint data is reduced relative to conventional techniques, which involve sending a stream containing multiple discrete frames. The processing burden on the host device is also reduced since the host is able to rely upon the “pre-checked” fingerprint frame and does not have to process an entire stream of fingerprint data.

In the discussion that follows, a section titled “Operating Environment” is provided that describes an example environment suitable to employ the communication of fingerprint data techniques described herein. Following this, a section titled “Fingerprint Data Communication Examples” describes example techniques, devices, arrangements, and details in accordance with one or more implementations. Last, a section titled “Example System” describes example computing systems and devices that can employ communication of fingerprint data in accordance with one or more implementations.

Operating Environment

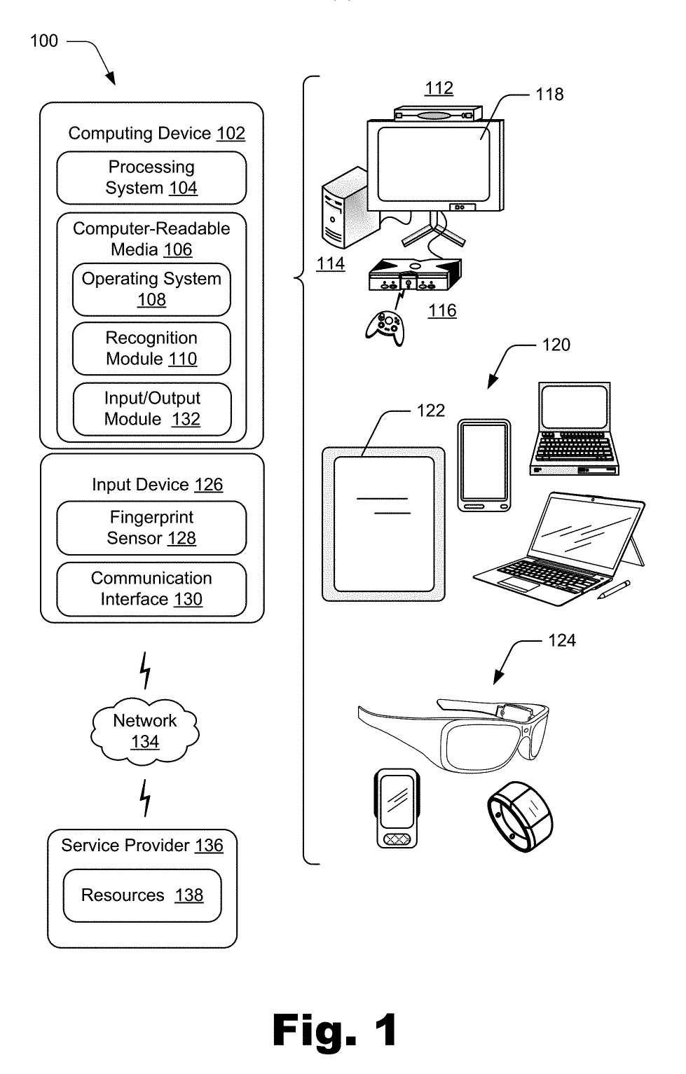

FIG. 1 illustrates an operating environment in accordance with one or more implementations, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, one or more applications (not shown), and a recognition module 110 that reside on the computer-readable media and which are executable by the processing system. As discussed in detail below, the recognition module 110 represents functionality for processing of fingerprint data and performing fingerprint recognition, authentication, and access control based on fingerprints represented by the fingerprint data. The processing system 104 may retrieve and execute computer-program instructions from applications to provide a wide range of functionality to the computing device 102, including but not limited to gaming, office productivity, email, media management, printing, networking, web-browsing, and so forth. A variety of data and program files related to the applications can also be included, examples of which include game files, office documents, multimedia files, emails, data files, web pages, user profile and/or preference data, and so forth.

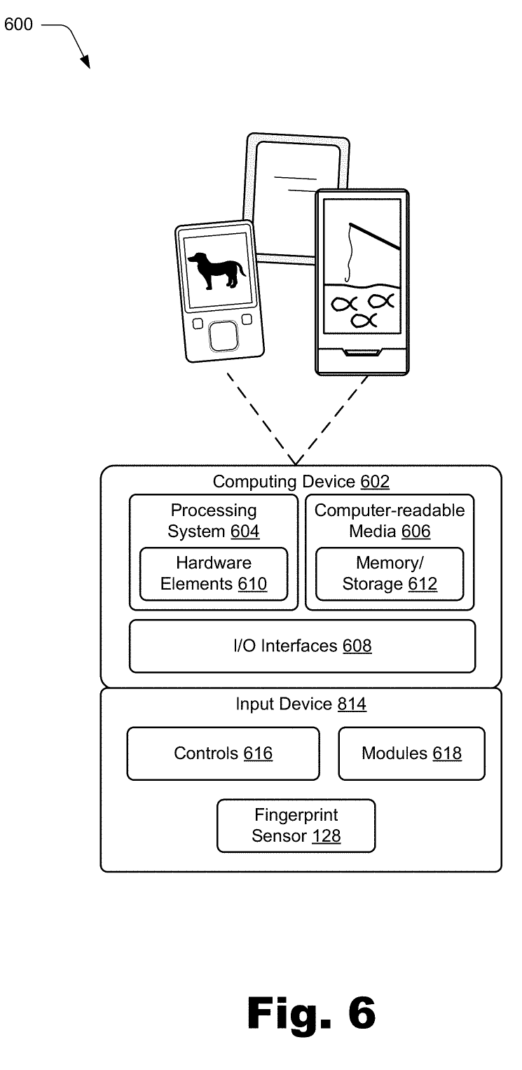

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to a ring, an article of clothing, a glove, and a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 6.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 6.

The computing device 102 may include or make use of an input device 126. In accordance with the principles described herein, the computing device 102 may be separate from, but communicatively coupled to one or more input devices 126 via any suitable communication connection, such as via a wireless communication connection (e.g., Bluetooth®, Near Field Communication (NFC), WiFi, and so on), a wired communication connection, a physical and communicative coupling using connectors in which one or more connectors of the input device 126 mate with one or more complimentary connectors of the computing device 102. In one or more implementations, the input device 126 may not be separate from the computing device 102, and may be communicatively coupled to the computing device 102 over a device bus or the like.

Input devices include devices communicatively integrated with the computing device 102, such as an integrated keyboard, touchpad, track pad, pointer device, a bezel or other touch operable component of a tablet or wearable device, a touch capable display, and so forth. Input devices also include external devices and removably connectable devices such as a mouse, wireless keyboard, removable keyboard/cover combination, a stylus a mobile phone, a wearable device used to control the computing device through a wireless connection, an external touchpad, and so forth. Other non-conventional configurations of an input device are also contemplated, such as a game controller, configuration to mimic a musical instrument, and so forth. Thus, the input device 126 and controls incorporated by the input device (e.g., buttons, keys, touch regions, toggles, etc.) may assume a variety of different configurations to support a variety of different functionality.

In accordance with one or more implementations described herein, the input device 126 includes a fingerprint sensor 128 that implements communication of fingerprint data for recognition to the computing device 102 and/or the recognition module 110. As introduced above, the recognition module 110 is capable of identifying users from fingerprint data and controlling access to resources accordingly. For example, the recognition module 110 represents functionality of the computing device to process fingerprint data captured by the fingerprint sensor 128 of the input device 126 for user identification and authentication. The recognition module 110 is configured to recognize that a fingerprint from a single frame of fingerprint data received from the input device 126 corresponds to a particular user. This may occur by comparing a fingerprint representation to a library of known fingerprints corresponding to different users. Based on the recognition, the recognition module 110 identifies a particular user and selectively provides access to resources the user is permitted to access. The recognition module 110 may be implemented as a driver, as part of an application, as part of an operating system, part of a library, through an application programming interface, and so on.

The fingerprint sensor 128 is configured to capture frames of fingerprint data (such as images or scans of fingerprints) that are indicative of unique patterns and features of prints used for user identification and authentication. The captured fingerprint data can be communicated (e.g., over the communication connections described above) from the input device 126 to the computing device 102 for processing by the recognition module 110. When captured is initiated by the computing device 102, by a user, in response to an application request or otherwise, the fingerprint sensor 128 of the input device is invoked to capture the fingerprint data. In accordance with techniques described herein, the input device 126 communicates a single frame of fingerprint data that is pre-processed to ensure quality to the computing device 102.

The input device 126 additionally includes a communication interface 130 configured to communicatively couple to the input device 126 to computing device 102 for exchange of data, commands, and signal. The communication interface 130 is operable to communication fingerprint data as well as other input signals can for processing by the computing device 102. The communication interface 130 is representative of various different types of interfaces and channels operable to form different communicative and/or physical communication connections including wireless connections, a wired connections, a connection through a device bus, a connection across mating connectors, a connection across an accessory interface, and so on.

The computing device 102 is further illustrated as including an input/output module 132 configured to process input signals received from the input device 126 and/or other sources. The input/output module 132 is representative of various functionality relating to processing of inputs and rendering outputs of the computing device 102. A variety of different inputs may be processed by the input/output module 132, such as inputs relating to operation of controls of the input device 126, keys of a virtual keyboard, identification of gestures through touchscreen functionality, and so forth. Responsive to the inputs, the input/output module 132 causes corresponding operations to be performed. Thus, the input/output module 132 may support a variety of different input techniques by recognizing and leveraging a division between types of inputs including key presses, gestures, control interaction, and so on.

The environment 100 further depicts a network 134, via which the computing device 102 and the input device 126 may be connected to a service provider 136. This enables the computing device 102 to access and interact with various resources 138 made available by the service provider 136. The resources 138 can include any suitable combination of content and/or services typically made available over a network by one or more service providers. For instance, content can include various combinations of text, video, ads, audio, multi-media streams, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of communication of fingerprint data.

Fingerprint Data Communication Examples

Example Devices and Operation Timeline

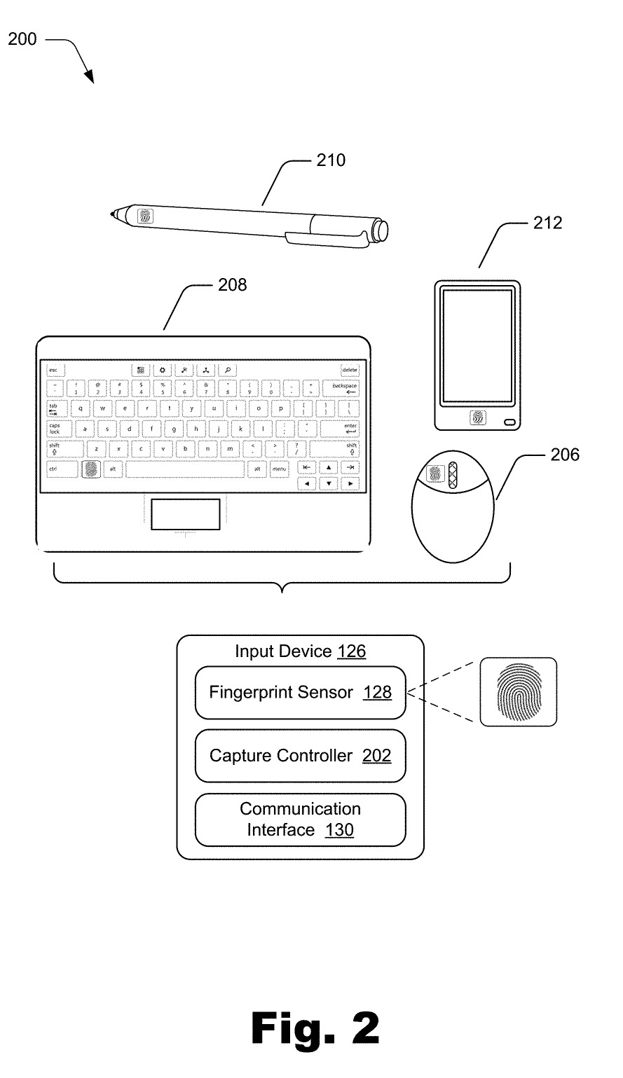

FIG. 2 depicts generally at 200 an example implementation of an input device 126 of FIG. 1 in greater detail. In the illustrated example, the input device 126 includes the fingerprint sensor 128, which may be configured in various ways as described in this document. The input device 126 also includes the communication interface 130, which represents any suitably configured communication interface operable to enable a communicative connection to a computing device. The communicative connection enables communications to supply fingerprint data from the input device 126 for processing by the computing device 102. The fingerprint data includes frames of data that are captured through operation of the fingerprint sensor 128 and are indicative of unique patterns and features of prints used for user identification and authentication.

As depicted, the fingerprint sensor 128 includes a capture controller 202. The fingerprint sensor 128 represents components configured to capture data indicative of a fingerprint, such as images, depth maps, surface normal information, capacitance information indicating finger contact with the fingerprint sensor 128, and so on. The fingerprint sensor 128 may be configured to capture one such type of data or, alternatively, configured to capture multiple different types of fingerprint data. In any case, the fingerprint sensor 128 represents functionality of the fingerprint sensor 128 to capture fingerprint data from which fingerprints can be recognized.

The capture controller 202 is configured to manage the fingerprint sensor 128 and the fingerprint data captured so that, in conjunction with each instance of user identification, a single frame of fingerprint data is selected and communicated to a host device, such as the computing device 102. In other words, a single frame of fingerprint data is communicated to the computing device 102 for a given user identification without communicating other frames of fingerprint data. To do so, the capture controller 202 performs quality analysis to determine that a fingerprint is recognizable from the single frame. The capture controller 202 may implemented as a microprocessor, a hardware controller, or fixed logic circuity include with the input device 126, although other configurations that enable management of the fingerprint sensor 128 and captured fingerprint data are also contemplated. By way of example and not limitation, the fingerprint sensor 128 and the capture controller 202 may be implemented in hardware, such as an integrated circuit (IC) die which includes both the fingerprint sensor 128 and the capture controller 202 is used. Alternatively, the capture controller 202 may represent a processing system implemented by the input device 126 and the fingerprint sensor 128 may be provided as a separate component of the input device 126.

In any case, to determine that a fingerprint is recognizable from a single frame of fingerprint data, the capture controller 202 is configured to analyze one or more quality indicators. Various quality indicators may be specified for capturing fingerprint data as criteria for selection of frames of fingerprint data. In general, the quality indicators are indicative of a quality of a frame of fingerprint data. Some quality indicators may indicate a quality of a frame that is to be captured, and some may indicate a quality of an already-captured frame.

By way of example, the quality indicators can include one or more indicators indicative of an amount of contact between a finger and the fingerprint sensor 128. An amount of contact can be determined in terms of surface area, a number of points of contact, and so forth. The quality indicators can also indicate characteristics of captured images that affect a quality of fingerprints depicted therein, such as clarity, brightness, contrast, resolution of a captured image, completeness of a frame, and so on. Additionally, the quality indicators may indicate a distance of a finger from the fingerprint sensor 128, distances of different portions of the finger from the fingerprint sensor 128, and so on. The quality indicators may also indicate a pressure applied by a finger on the fingerprint sensor 128, a position of a finger relative to the fingerprint sensor 128, and so on. The capture controller 202 may analyze a variety of other quality indicators without departing from the spirit or the scope of the techniques described herein.

In one or more implementations, the analysis can involve a determination as to whether quality indicators meet or exceed certain thresholds. In an example in which an amount of contact is considered, the analysis can involve determining whether an amount of contact between a finger and the fingerprint sensor 128 meets or exceeds a threshold amount of contact associated with capturing recognizable fingerprints. Consider that in this example an amount of contact is defined in terms of a number of points of contact, such that the threshold amount of contact is specified as a certain number of points of contact, e.g., at least X points of contact between a finger and the fingerprint sensor 128. Thus, if the number of contact points between a finger and the fingerprint sensor 128 equals or is greater than X points, then an analysis may indicate that a fingerprint from the corresponding frame of fingerprint data meet the quality threshold and will be recognizable. If the number of contact points is fewer than X points, however, then the analysis may indicate that a fingerprint from the corresponding frame of fingerprint data does not meet the threshold and therefor may not be recognizable. Likewise, the analysis can involve determining whether a distance of a finger from the fingerprint sensor 128 is within a threshold distance, whether an amount of pressure applied by a finger to the fingerprint sensor 128 is at a threshold pressure level, and so on.

As mentioned briefly above, the analysis of the quality indicators can be performed before capture of fingerprint data. In this way, the analysis can be used to control when the fingerprint sensor 128 captures the fingerprint data. As a result, the fingerprint sensor 128 may be employed to capture just a single frame of fingerprint data (e.g., a single image) in conjunction with a particular user identification based on the quality checks (e.g., contact, pressure, etc.). For a given user identification performed by the computing device 102, the fingerprint sensor 128 may thus capture a single frame of fingerprint data without capturing other frames.

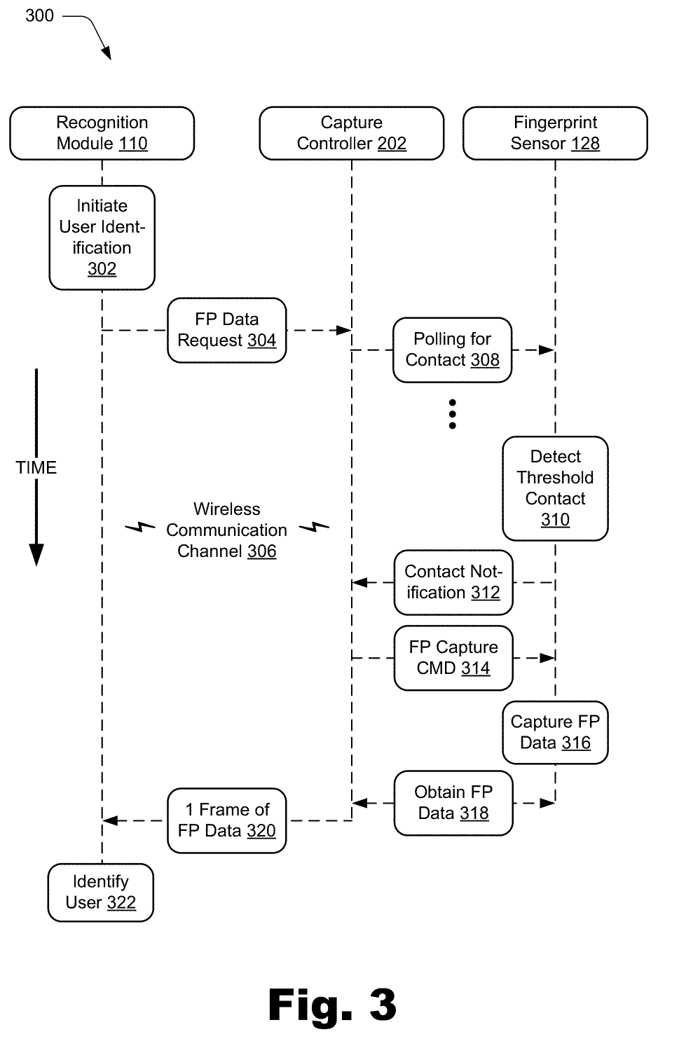

Alternately, the analysis can be performed after capture of the fingerprint data. In this scenario, an analysis can indicate which one of multiple captured frames is to be communicated to the computing device 102. Based on the analysis, the capture controller 202 can select the indicated frame for communication to the computing device 102. In either case, the capture controller 202 employs the communication interface 130 to communicate a single frame of fingerprint data to the computing device 102 for a given fingerprint-based user identification. Details regarding a particular example of capturing fingerprint data and performing an analysis so that a single frame of fingerprint data includes a recognizable fingerprint are discussed below in relation to FIG. 3.

As noted, the fingerprint data communication techniques as described in this document may be used with various electronic devices. Some illustrative example devices are represented in FIG. 2. For example, the fingerprint sensor 128 may be employed to implement fingerprint-based user identification techniques using a mouse 206, keyboard 208, stylus 210, or other input device 126. The fingerprint sensor 128 may also be used to implement user identification by the computing device through a mobile device 212, such as a mobile phone, tablet, camera, wearable device, or portable digital media player. This may be the case, for instance, when the mobile device 212 is configured for control of the computing device 102, e.g., as a remote control. The fingerprint sensor 128 may also be used in connection with dedicated finger-scanning devices, configured for providing input signals corresponding to fingerprint data to the computing device 102, but not for providing other input signals, such as those indicative of typed keys, cursor location, and so forth.

Consider now details regarding an example implementation of capturing fingerprint data and performing an analysis so that a single frame includes a recognizable fingerprint discussed in relation to FIG. 3. In particular, FIG. 3 depicts generally at 300 a timeline of operations performed by and data communicated between particular components of the environment 100 of FIG. 1, including components of the input device as depicted in FIG. 2. In this particular example, the communication connection between the input device 126 and the computing device is a wireless connection, although in implementations wired connection and other communicative couplings may be used. Further, the example illustrates operations performed by and data communicated between the recognition module 110, the capture controller 202, and the fingerprint sensor 128. On the left-hand side of the illustration, an arrow indicates the direction of time, such that operations and communications of data at the top of the illustration occur before operations and communications of data at the bottom of the illustration.

In this example, the recognition module 110 of the computing device initiates a user identification 302. The recognition module 110 may do so for the purpose of unlocking the computing device 102 or the input device 126 from a power-saving or sleep mode, authenticating a user to the computing device 102 or the input device 126, authenticating a user for authorization to use a service provided by a service provider (e.g., banking, making online purchases, checking in for travel, purchasing tickets, and so on), signing electronic forms or documents, and so forth. As part of performing the user identification, the recognition module 110 may communicate a fingerprint data request 304 over the wireless communication channel 306, which is received at the input device for processing by the capture controller 202.

Based on the fingerprint data request 304, the capture controller 202 may analyze the above discussed quality indicators specified for capturing fingerprint data as criteria for selection of frames of fingerprint data. In the example illustrated in FIG. 3, the analysis is performed prior to capturing fingerprint data, although in some implementations the analysis may be performed on already-captured fingerprint data as discussed above and below. In particular, FIG. 3 illustrates an example in which the analysis is performed with respect to indicators that indicate contact of a finger with the fingerprint sensor 128.

The analysis may determine when a finger has at least a threshold amount of contact with the fingerprint sensor 128, for instance. In so doing, the capture controller 202 polls 308 the fingerprint sensor 128 regarding contact of the finger with the fingerprint sensor 128. The capture controller 202 may continue to poll 308 the fingerprint sensor 128 at predetermined intervals of time, until sufficient contact with the fingerprint sensor 128 is detected. The term “sufficient contact” as used herein refers to a scenario in which contact of a finger with the fingerprint sensor 128 meets a threshold amount of contact associated with capturing recognizable fingerprints.

Continuing with the illustrated example, the fingerprint sensor 128 detects a threshold amount of contact 310 (e.g., a minimum amount of contact associated with capturing fingerprints that are recognizable as corresponding to particular users) between a finger and the fingerprint sensor 128. Once the threshold amount of contact is detected, the fingerprint sensor 128 communicates (over a device bus or the like) a contact notification 312 to the capture controller 202. The capture controller 202 then issues a fingerprint data capture command 314 to the fingerprint sensor 128. Based on the fingerprint data capture command 314, the fingerprint sensor 128 captures the fingerprint data 316.

As mentioned above, frames of fingerprint data may correspond to images, depth maps, surface normal information, capacitance information, and so on. As also mentioned above, the capture may involve capture of a single frame of fingerprint data in some implementations. The scenario represented by FIG. 3, corresponds to capture of a single frame of fingerprint data. In other scenarios, such as when the capture controller 202 analyzes the quality indicators after capture, the fingerprint sensor 128 may be commanded to capture multiple frames of fingerprint data.

Returning to the illustrated example, the capture controller 202 obtains the fingerprint data 318 from the fingerprint sensor 128, e.g., the capture controller 202 obtains a single image captured by the fingerprint sensor 128. The capture controller 202 then communicates the single frame of fingerprint data 320 over the wireless communication channel 306 to the computing device 102, where it can be processed by the recognition module 110. The recognition module 110 then processes the single frame of fingerprint data to recognize the fingerprint and thereby identify the corresponding user 322. Additional examples and details are discussed in relation to the following example procedures.

Example Procedures

To further illustrate, consider the discussion in this section of example procedures and implementation details related to communication of fingerprint data. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

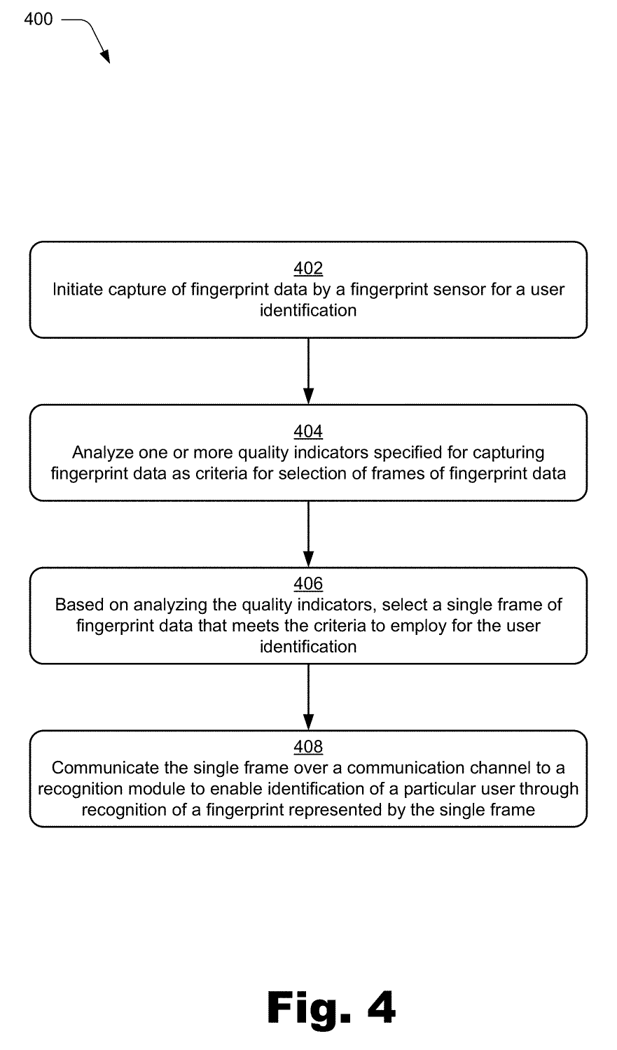

FIG. 4 depicts an example procedure 400 for reducing an amount of fingerprint data communicated by a fingerprint sensor in association with a fingerprint-based user identification in accordance with one or more implementations. Capture of fingerprint data by a fingerprint sensor is initiated for a user identification (block 402). For example, the input device 126 may receive a request for fingerprint data from the computing device 102. The request may be generated for different interaction scenarios such as purchase transactions, document signing, authentication to access local or remote resource, account sign-in, and so forth In particular, the input device 126 receives the request through a communication connection with the computing device, such as a communication connection configured as a wireless connection, a wired connection, a connection through a device bus, a connection between mating connectors, a connection across an accessory interface, and so on. In implementations, the input device 126 and the computing device 102 may be communicably coupled via a wireless communication channel, but are not connected via a wired connection or with mating connectors.

In implementations, capture of fingerprint data may be initiated by interaction of the user with the input device 126. For example, a user may place a finger upon the fingerprint sensor 128 of the input device to log-in to the host device or to access a particular user account, which triggers the capture process. In this scenario, capture of fingerprint data may be initiated without a request from the host first being exchanged. Thus, if the host device is in a sleep state or suspended state, the user can still trigger capture of fingerprint data and communication of the captured frame may be effective to “wake-up” the host to process the captured frame and take corresponding actions.

Further, a communication coupling between the input device 126 and the computing device 102 may be separate from a physical coupling that is operable to attach the input device 126 to the computing device 102, such as via a mechanical or magnetic coupling used to couple an input device configured as a protective or decorative cover (with or without a keyboard) to the computing device. Alternately, the communication coupling may be integral with the physical coupling such that mating connectors that enable communications between the input device 126 and the computing device 102 also physically attach the devices.

One or more quality indicators are analyzed that are specified for capturing fingerprints as criteria for selection of frames of fingerprint data (block 404). For example, the capture controller 202 analyzes the one or more quality indicators specified for capturing fingerprints as criteria for selection of frames of fingerprint data. In scenarios in which the analysis is performed before capturing fingerprint data, the quality indicators can indicate when a quality of contact between a finger and the fingerprint sensor 128 would result in capture of a single frame of finger print data from which a fingerprint can be recognized. In scenarios in which the analysis is performed after the fingerprint data is captured, the quality indicators can indicate which of multiple frames of already-captured data have a recognizable fingerprint. As discussed above, the quality indicators can indicate a pressure of a finger against the fingerprint sensor 128, an amount of contact between the finger and the fingerprint sensor 128 (e.g., in terms of surface area or number of points), a completeness of a frame, a resolution, or other qualities.

Based on analyzing the quality indicators, a single frame of fingerprint data that meets the criteria is selected to utilize for the user identification (block 406). For example, in the scenario in which the analysis is performed before capture, the capture controller 202 selects a single frame of fingerprint data by employing the fingerprint sensor 128 to capture the single frame. In the scenario in which the analysis is performed after capture, the capture controller 202 simply causes one of the already-captured frames of fingerprint data to be selected. In both scenarios, the capture controller 202 selects a single frame of data for which the quality indicators indicate that the criteria for selection of frames of fingerprint data are met.

The single frame of fingerprint data is communicated over a communication channel to a recognition module (block 408). In accordance with the principles discussed herein, the single frame enables the recognition module to identify a particular user by recognition of a fingerprint represented by the single frame. For example, the capture controller 202 employs the communication interface 130 to communicate the single frame of fingerprint data selected at block 406 to the recognition module 110 of the computing device 102. The single frame of data may be communicated to the recognition module 110 over a wireless connection, a wired connection, a connection through a device bus, a connection between mating connectors, a connection across an accessory interface, and so on.

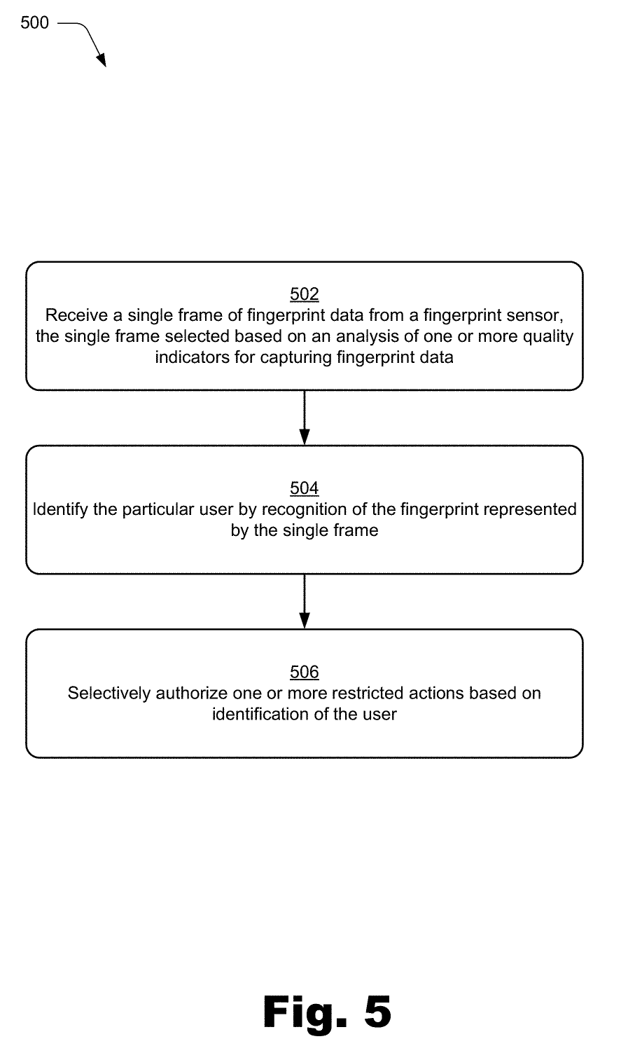

FIG. 5 depicts an example procedure 500 for utilizing fingerprint data efficiently obtained from a fingerprint sensor in association with a fingerprint-based user identification in accordance with one or more implementations. A single frame of fingerprint data is received from a fingerprint sensor (block 502). In accordance with principles discussed herein, an input device configured with a fingerprint sensor is communicatively coupled with a computing device having a recognition module that uses fingerprint data to identify users, the fingerprint sensor captures data responsive to an indication from the recognition module to initiate capture, and a single frame of the fingerprint data is communicated to the computing device from the fingerprint sensor over a communication connection. For example, the recognition module 110 receives a single frame of fingerprint data from the fingerprint sensor 128, such as one communicated to the recognition module 110 as at block 408. The single frame of fingerprint data is selected as described above based on an analysis of one or more quality indicators for capturing finger print data. In particular, the one or more quality indicators indicate that a fingerprint represented by the single frame is recognizable as corresponding to a particular user.

The particular user is identified by recognition of the of the fingerprint represented by the single frame (block 504). For example, the recognition module 110 recognizes a fingerprint from the single frame of data received at block 502. In particular, the recognition module 110 recognizes the fingerprint as corresponding to a particular user. Additionally, the recognition module 110 recognizes the fingerprint from the single frame without using an additional frame of fingerprint data. Based on recognition of the fingerprint (e.g., by extracting the fingerprint and comparing the fingerprint candidate to templates of known fingerprints), the recognition module 110 can identify the user whose fingerprint was captured by the fingerprint sensor 128. In this way the recognition module 110 can authenticate users.

One or more restricted actions are selectively authorized based on identification of the user (block 508). For example, a particular user may be permitted to perform one or more restricted actions via at least one of the input device 126 or the computing device 102. Based on identification of the user whose fingerprint was captured as the particular user, the recognition module 110 authorizes the identified user to perform the restricted actions. Examples of restricted actions can include but are not limited to unlocking the computing device 102 or the input device 126 from a power-saving, sleep, hibernation, or lock mode, or authenticating the user to the computing device 102, the input device 126 (e.g., to apply custom device settings, user experience settings), or to an operating system and other applications. The unlocking of the input device and/or the computing device is effective to enable the input device to exchange input signals, commands, and other data with the computing device. Examples of restricted actions also include using a service provided by a service provider (e.g., banking, making online purchases, checking in for travel, and so on), signing electronic forms or documents, purchase transactions, access control to resources, account sign-on, device log-in, and so forth. Restricted actions can include still other actions without departing from the spirit or scope of the techniques described herein.

Having considered example details and procedures for communication of fingerprint data, consider a discussion of an example system in accordance with one or more implementations.

Example System and Device

FIG. 6 illustrates an example system generally at 600 that includes an example computing device 602 that is representative of one or more computing systems and/or devices that may implement the various techniques described herein. The computing device 602 may, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to the computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways to support user interaction.

The computing device 602 is further illustrated as being communicatively and physically coupled to an input device 614 that is physically and communicatively removable from the computing device 602. In this way, a variety of different input devices may be coupled to the computing device 602 having a wide variety of configurations to support a wide variety of functionality. In this example, the input device 614 includes one or more controls 616. The controls may be configured as pressure sensitive elements, buttons, a trackpad mechanically switched keys, and so forth.

The input device 614 is further illustrated as include one or more modules 618 that may be configured to support a variety of functionality. The one or more modules 618, for instance, may be configured to process analog and/or digital signals received from the controls 616 to recognize inputs and gesture, determine whether an input is indicative of resting pressure, initiate communication with a computing device, support authentication of the input device 614 for operation with the computing device 602, and so on. The input device 614 may also be configured to incorporate a fingerprint sensor 128 that communicates single frames of fingerprint data to the computing device 602 as previously described.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” refers to media and/or devices that enable persistent storage of information in contrast to mere signal transmission, carrier waves, or signals per se. Thus, computer-readable storage media does not include transitory media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

### EXAMPLE IMPLEMENTATIONS

Example implementations of techniques described herein include, but are not limited to, one or any combinations of one or more of the following examples:

### Example 1

A method for reducing an amount of fingerprint data communicated by a fingerprint sensor in association with a fingerprint-based user identification, the method comprising: initiating capture of the fingerprint data by the fingerprint sensor for the user identification; analyzing one or more quality indicators specified for capturing fingerprint data as criteria for selection of frames of fingerprint data; based on analyzing of the quality indicators, selecting a single frame of fingerprint data that meets the criteria to utilize for the user identification; and communicating the single frame over a communication channel to a recognition module, the single frame enabling the recognition module to identify a particular user by recognition of a fingerprint represented by the single frame.

### Example 2

A method as described in any one or more of the examples in this section, wherein: at least one of the quality indicators indicates whether an amount of contact between a finger of the particular user and the fingerprint sensor exceeds a threshold amount of contact associated with capturing recognizable fingerprints; and the selecting further includes employing the fingerprint sensor to capture the single frame responsive to the at least one quality indicator indicating that the amount of contact exceeds the threshold amount of contact.

### Example 3

A method as described in any one or more of the examples in this section, wherein the amount of contact and the threshold amount of contact are amounts of surface area.

### Example 4

A method as described in any one or more of the examples in this section, wherein the amount of contact and the threshold amount of contact are numbers of contact points.

### Example 5

A method as described in any one or more of the examples in this section, wherein the single frame is captured in conjunction with the user identification without capturing other frames of fingerprint data.

### Example 6

A method as described in any one or more of the examples in this section, wherein other frames of fingerprint data are not communicated to the computing device in conjunction with the user identification.

### Example 7

A method as described in any one or more of the examples in this section, wherein the single frame is a single image of the fingerprint.

### Example 8

A method as described in any one or more of the examples in this section, wherein the communication channel is a wireless communication channel.

### Example 9

A method as described in any one or more of the examples in this section, wherein the communication channel is implemented over at least one of a wired connection, a device bus connection, or a connection across mating connectors of a device that integrates the fingerprint sensor and of a computing device that includes the recognition module.

### Example 10

A method as described in any one or more of the examples in this section, wherein the fingerprint sensor is not communicably coupled to the recognition module via a wired communication channel.

### Example 11

A device comprising: a fingerprint sensor operable to capture fingerprint data for identifying corresponding users; a communication interface to communicate the fingerprint data over a communication channel to a computing device; and computer-readable media having instructions stored thereon that are executable by the device to perform operations for reducing an amount of fingerprint data communicated in association with a fingerprint-based user identification, the operations comprising: responsive to a determination that a finger of a user is positioned with respect to the fingerprint sensor to enable capture of recognizable fingerprint data, causing the fingerprint sensor to capture the recognizable fingerprint data; selecting a frame of the recognizable fingerprint data based on an analysis of one or more quality indicators for capturing fingerprint data; and communicating the selected frame over the communication channel to the computing device using the communication interface, the selected frame enabling the computing device to identify the user based on recognition of a fingerprint represented by the selected frame.

### Example 12

A device as described in any one or more of the examples in this section, wherein the fingerprint sensor is operable to capture the fingerprint data as images.

### Example 13

A device as described in any one or more of the examples in this section, further comprising a housing having a form factor of at least one of: a protective case of the computing device; a decorative case of the computing device; a keyboard; a mouse; or a stylus.

### Example 14

A device as described in any one or more of the examples in this section, wherein the communication interface is further configured for wired communication with the computing device and communication over mating connectors of the device and the computing device.

### Example 15

A device as described in any one or more of the examples in this section, wherein the operations further comprise polling the fingerprint sensor to determine whether contact between the finger of the user and the fingerprint sensor enables the capture of the recognizable fingerprint data.

### Example 16

A device as described in any one or more of the examples in this section, wherein the operations further comprise: receiving, by the communication interface and via the communication channel, a request for the fingerprint data from the computing device; and responsive to receiving the request, initiating the polling.

### Example 17

A method implemented by a computing device for utilizing fingerprint data efficiently obtained from a fingerprint sensor in association with a user identification, the method comprising: receiving, by the computing device, a single frame of the fingerprint data from the fingerprint sensor in association with the user identification, the single frame selected based on an analysis of one or more quality indicators for capturing fingerprint data that indicate a fingerprint represented by the single frame is recognizable as corresponding to a particular user; identifying the particular user by recognition of the fingerprint represented by the single frame; and selectively authorizing one or more restricted actions based on identification of the particular user.

### Example 18

A method as described in any one or more of the examples in this section, wherein the fingerprint sensor is integrated in an input device to the computing device, and the selective authorizing unlocks at least one of the input device or the computing device to enable the input device to provide input to the computing device.

### Example 19

A method as described in any one or more of the examples in this section, wherein the restricted actions include at least one action associated with a service provided by a service provider.

### Example 20

A method as described in any one or more of the examples in this section, wherein the identifying is performed using the fingerprint represented by the single frame of fingerprint data without using an additional frame of the fingerprint data.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method for reducing an amount of fingerprint data communicated by a fingerprint sensor in association with a fingerprint-based user identification, the method comprising:
initiating capture of the fingerprint data by the fingerprint sensor for the user identification;
analyzing one or more quality indicators specified for capturing fingerprint data as criteria for selection of frames of fingerprint data;
based on analyzing of the quality indicators, selecting a single frame of fingerprint data that meets the criteria to utilize for the user identification; and
communicating the single frame over a communication channel to a recognition module, the single frame enabling the recognition module to identify a particular user by recognition of a fingerprint represented by the single frame.

2. A method as described in claim 1, wherein:
at least one of the quality indicators indicates whether an amount of contact between a finger of the particular user and the fingerprint sensor exceeds a threshold amount of contact associated with capturing recognizable fingerprints; and
the selecting further includes employing the fingerprint sensor to capture the single frame responsive to the at least one quality indicator indicating that the amount of contact exceeds the threshold amount of contact.

3. A method as described in claim 2, wherein the amount of contact and the threshold amount of contact are amounts of surface area.

4. A method as described in claim 2, wherein the amount of contact and the threshold amount of contact are numbers of contact points.

5. A method as described in claim 2, wherein the single frame is captured in conjunction with the user identification without capturing other frames of fingerprint data.

6. A method as described in claim 1, wherein other frames of fingerprint data are not communicated to the computing device in conjunction with the user identification.

7. A method as described in claim 1, wherein the single frame is a single image of the fingerprint.

8. A method as described in claim 1, wherein the communication channel is a wireless communication channel.

9. A method as described in claim 1, wherein the communication channel is implemented over at least one of a wired connection, a device bus connection, or a connection across mating connectors of a device that integrates the fingerprint sensor and of a computing device that includes the recognition module.

10. A method as described in claim 1, wherein the fingerprint sensor is not communicably coupled to the recognition module via a wired communication channel.

11. A device comprising:
a fingerprint sensor operable to capture fingerprint data for identifying corresponding users;
a communication interface to communicate the fingerprint data over a communication channel to a computing device; and
computer-readable media having instructions stored thereon that are executable by the device to perform operations for reducing an amount of fingerprint data communicated in association with a fingerprint-based user identification, the operations comprising:
responsive to a determination that a finger of a user is positioned with respect to the fingerprint sensor to enable capture of recognizable fingerprint data, causing the fingerprint sensor to capture the recognizable fingerprint data;
selecting a frame of the recognizable fingerprint data based on an analysis of one or more quality indicators for capturing fingerprint data; and
communicating the selected frame over the communication channel to the computing device using the communication interface, the selected frame enabling the computing device to identify the user based on recognition of a fingerprint represented by the selected frame.

12. A device as described in claim 11, wherein the fingerprint sensor is operable to capture the fingerprint data as images.

13. A device as described in claim 11, further comprising a housing having a form factor of at least one of:
a protective case of the computing device;
a decorative case of the computing device;
a keyboard;
a mouse; or
a stylus.

14. A device as described in claim 11, wherein the communication interface is further configured for wired communication with the computing device and communication over mating connectors of the device and the computing device.

15. A device as described in claim 11, wherein the operations further comprise polling the fingerprint sensor to determine whether contact between the finger of the user and the fingerprint sensor enables the capture of the recognizable fingerprint data.

16. A device as described in claim 15, wherein the operations further comprise:
receiving, by the communication interface and via the communication channel, a request for the fingerprint data from the computing device; and
responsive to receiving the request, initiating the polling.

17. A method implemented by a computing device for utilizing fingerprint data efficiently obtained from a fingerprint sensor in association with a user identification, the method comprising:
receiving, by the computing device, a single frame of the fingerprint data from the fingerprint sensor in association with the user identification, the single frame selected based on an analysis of one or more quality indicators for capturing fingerprint data that indicate a fingerprint represented by the single frame is recognizable as corresponding to a particular user;
identifying the particular user by recognition of the fingerprint represented by the single frame; and
selectively authorizing one or more restricted actions based on identification of the particular user.

18. A method as described in claim 17, wherein the fingerprint sensor is integrated in an input device to the computing device, and the selective authorizing unlocks at least one of the input device or the computing device to enable the input device to provide input to the computing device.

19. A method as described in claim 17, wherein the restricted actions include at least one action associated with a service provided by a service provider.

20. A method as described in claim 17, wherein the identifying is performed using the fingerprint represented by the single frame of fingerprint data without using an additional frame of the fingerprint data.
